(19) United States
(12) Patent Application Publication
(10) Pub. No.: US 2016/0274501 A1
(43) Pub. Date: Sep. 22, 2016

(54) IMAGE FORMING APPARATUS

(71) Applicant: CANON KABUSHIKI KAISHA, Tokyo (JP)

(72) Inventor: Yuusuke Torimaru, Toride-shi (JP)

(21) Appl. No.: 15/070,581

(22) Filed: Mar. 15, 2016

(30) Foreign Application Priority Data
Mar. 17, 2015 (JP) 2015-054039

(51) Int. Cl. G03G 15/01

(52) U.S. Cl. CPC G03G 15/1615

(57) ABSTRACT

An image forming apparatus includes image bearing members; an image forming unit; a movable endless belt, transfer members provided in contact with an inner peripheral surface of the belt and in neighborhoods of the transfer portions, wherein each of the transfer members is disposed at a position shifted toward a downstream side relative to an associated contact portion with respect to a movement direction of the belt, a voltage source, and an urging member for urging the belt to an associated image bearing member in contact with the inner peripheral surface of the belt. The urging member is provided correspondingly to at least one of the image bearing members.

### FIELD OF THE INVENTION AND RELATED ART

The present invention relates to an image forming apparatus, such as a copying machine, a printer or a facsimile machine, using an electrophotographic type or an electrostatic recording type.

Conventionally, in an electrophotographic image forming apparatus including an intermediary transfer member, as disclosed in Japanese Laid-Open Patent Application 2006-259639, a metal roller is used as a transfer roller in some cases. The metal roller itself is an electroconductive member, and therefore, there is a substantially no fluctuation in electric resistance due to a fluctuation in environment or a fluctuation in durability, and necessity to effect high voltage control such as ATVC control becomes low. Further, the metal roller itself is inexpensive compared with an elastic roller.

However, in the case where the metal roller is used as the transfer roller, for example, it turned out that an image defect due to a shock given to the intermediary transfer member is liable to generate.

In the case where the metal roller is used as the transfer roller, the transfer roller is disposed at a position where the transfer roller contacts the intermediary transfer member and the intermediary transfer member does not contact a photosensitive member, i.e., the transfer roller does not oppose the photosensitive member via the intermediary transfer member. This is because a large change, in current supplied to a primary transfer portion, due to a difference in image ratio with respect to a longitudinal direction of the transfer roller is suppressed. For example, a position of the transfer roller relative to the photosensitive member is a position offset to a downstream side by about 4-10 mm with respect to a movement direction of the intermediary transfer member.

Thus, in a constitution in which the transfer roller does not oppose the photosensitive member via the intermediary transfer member, compared with a constitution in which the transfer roller opposes the photosensitive member via the intermediary transfer member a force of constraint between the photosensitive member and the intermediary transfer member becomes weak. As a result for example, shock when thick paper as a recording material enters a secondary transfer portion is liable to be transmitted to the primary transfer portion, so that an image defect due to the shock (i.e., a shock image) is liable to generate. This shock image is such a phenomenon that a speed fluctuation of the intermediary transfer member generates when a leading end of the thick paper or the like enters the secondary transfer portion and at this time, an image positioned at the primary transfer portion becomes dense (thick).

### SUMMARY OF THE INVENTION

The above problem is solved by an image forming apparatus according to the present invention. According to an aspect of the present invention, there is provided an image forming apparatus comprising: a plurality of image bearing members; an image forming unit for forming toner images on the image bearing members, respectively; a movable endless belt onto which the toner images are transferred from the image bearing members at a plurality of transfer portions corresponding to the image bearing members, respectively, wherein each of the transfer portions is a contact portion where an outer peripheral surface of the belt and an associated image bearing member are in contact with each other; a plurality of transfer members provided in contact with an inner peripheral surface of the belt and in neighborhoods of the transfer portions, wherein each of the transfer members is disposed at a position shifted toward a downstream side relative to an associated contact portion with respect to a movement direction of the belt; a voltage source for applying a voltage to the transfer members; and an urging member for urging the belt to an associated image bearing member in contact with the inner peripheral surface of the belt, the urging member being provided correspondingly to at least one of the image bearing members.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus (full-color mode) in Embodiment 1.

FIG. 2 is a schematic sectional view of an image forming apparatus (black monochromatic mode) in Embodiment 1.

In FIG. 3, (a) and (b) are schematic views showing arrangements of a primary transfer roller and a back-up member, respectively.

FIG. 4 is a schematic view showing another arrangement of the back-up member.

FIG. 5 is a block diagram showing a schematic control mode of a principal part of the image forming apparatus.

FIG. 6 is a flowchart of an image outputting operation.

FIG. 7 is a graph for illustrating a rotation fluctuation, due to shock, of a driving roller for an intermediary transfer belt.

FIG. 8 is an illustration of a measurement result of the rotation fluctuation, due to the shock, of the driving roller for the intermediary transfer belt.

FIG. 9 is a schematic sectional view of an image forming apparatus (full-color mode) in Embodiment 2.

FIG. 10 is a schematic sectional view of an image forming apparatus (full-color mode) in another embodiment to which the present invention is applicable.

### DESCRIPTION OF THE EMBODIMENTS

An image forming apparatus according to the present invention will be described with reference to the drawings.

### Embodiment 1

### 1. General Structure and Operation of Image Forming Apparatus

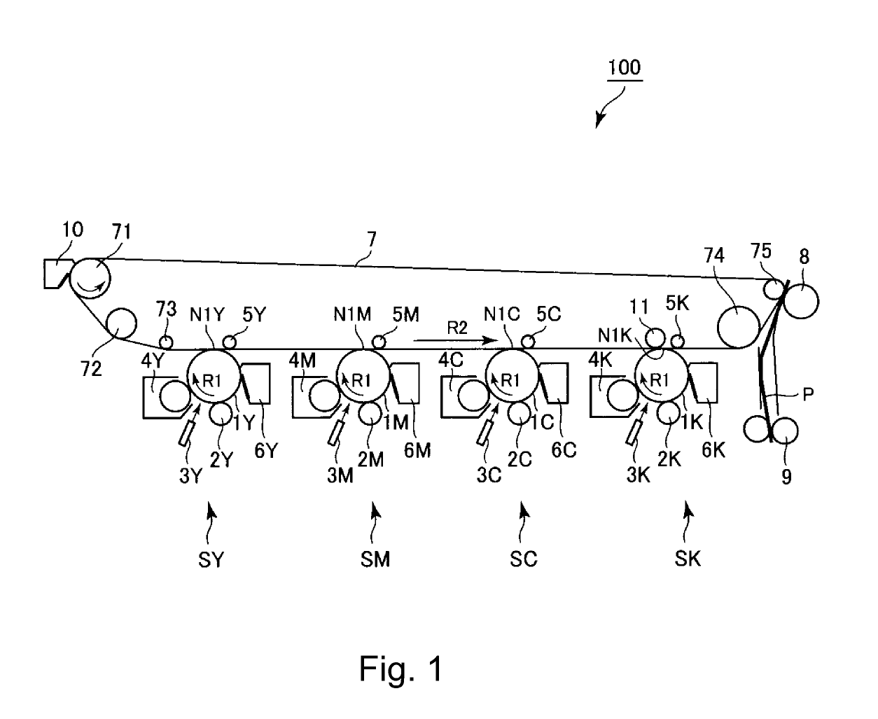

FIG. 1 is a schematic sectional view of an image forming apparatus 100 in this embodiment according to the present invention.

The image forming apparatus 100 in this embodiment is a tandem-type laser beam printer which is capable of forming a full-color image using an electrophotographic type and which employs an intermediary transfer type.

The image forming apparatus 100 includes, as a plurality of image forming portions, first to fourth image forming portions (stations) SY, SM, SC and SK are arranged in a line in the listed order along a rotational direction of an intermediary transfer belt 7 described later and form images of yellow (Y), magenta (M), cyan (C) and black (K), respectively.

Incidentally, in the case where particular distinction is not required for elements having the same functions and constitutions provided correspondingly to the image forming portions SY, SM, SC and SK, suffixes Y, M, C and K for representing elements for associated colors, respectively, are omitted, and the elements will be collectively described. Further, the elements for the colors are distinguished by adding prefixes Y, M, C and K thereto in some cases.

At the image forming portion S, a photosensitive drum 1 which is a drum-shaped (cylindrical) electrophotographic photosensitive member as a rotatable image bearing member is provided. The photosensitive drum 1 is rotationally driven in an arrow R1 direction at a predetermined peripheral speed. At a periphery of the photosensitive drum 1, the following electrophotographic process devices are provided in the listed order along a rotational direction of the photosensitive drum 1. First, a charging roller 2 which is a roller-shaped charging member as a charging means is disposed. Next, an exposure device (laser scanner) 3 as an exposure means is disposed. Next, a developing device 4 as a developing means is disposed. Next, a primary transfer roller (metal roller) 5 which is a roller-shaped primary transfer member as a primary transfer means. Next, a drum cleaning device 6 as a photosensitive member cleaning means is disposed. In this embodiment, the charging roller 2, the exposure device 3, the developing device 4 and the like constitute an image forming means for forming a toner image on the image bearing member.

Further, the image forming apparatus 100 includes, as a rotatable intermediary transfer member, the intermediary transfer belt 7 constituted by an endless belt disposed opposed to the photosensitive drums 1 of all of the image forming portions. The intermediary transfer belt 7 is an example of a rotatable endless belt onto which the toner images are transferred from the plurality of image bearing members at contact portions with the plurality of image bearing members. The intermediary transfer belt 7 is stretched by, as a plurality of stretching rollers (supporting rollers), a driving roller 71, a tension roller 72, first and second idler rollers 73, 74 and a secondary transfer opposite belt (inner secondary transfer roller) 75. As the intermediary transfer belt 7, a belt obtained by incorporating an anti-static agent such as carbon black in a proper amount into a resin such as polyimide or polyamine or into various rubbers or the like is used. In this embodiment, the intermediary transfer belt 7 is 1×10⁹-5×10¹¹ Ω/square in surface resistivity. In this embodiment, the intermediary transfer belt 7 is constituted by a film-like endless belt of about 0.04-0.5 mm in thickness, for example. By transmitting a driving force to the driving roller 71, the intermediary transfer belt 7 is circulated and driven (rotated) in an arrow R2 direction in the figure to a predetermined peripheral speed. The driving roller 71 is driven by a motor excellent in constant-speed property and circulates and drives the intermediary transfer belt 7. The tension roller gives a certain tension to the intermediary transfer belt 7. The first and second idler rollers 73, 74 supports the intermediary transfer belt 7 extending along an arrangement direction of the photosensitive drums 1. The secondary transfer opposite roller 75 forms a secondary transfer portion N2 in cooperation with a secondary transfer roller 8 described later. In this embodiment, the tension roller 72 is constituted so that a belt tension is about 3-12 kgf.

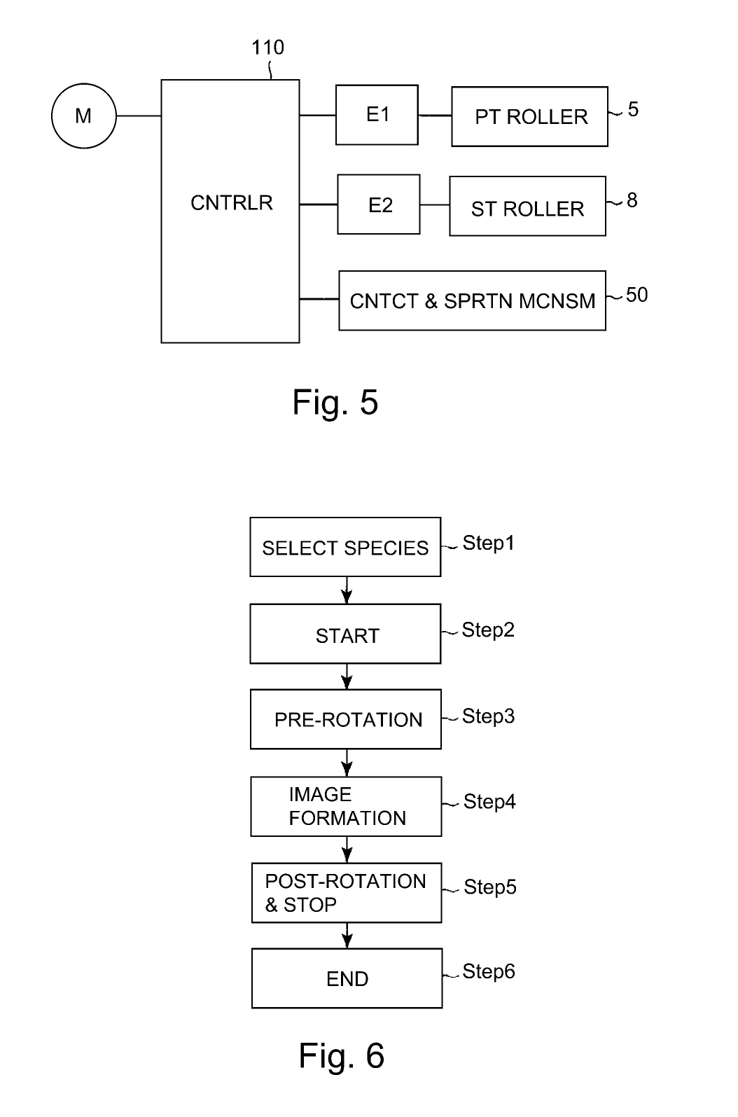

In an inner peripheral (back) surface side of the intermediary transfer belt 7, correspondingly to the photosensitive drums 1Y, 1M, 1C, 1K, the above-described transfer primary rollers 5Y, 5M, 5C, 5K are disposed. Each of the primary transfer rollers 5 causes the intermediary transfer belt 7 to contact the associated photosensitive drum 1, so that a primary transfer portion (primary transfer nip) N1 which is a contact portion between the intermediary transfer belt 7 and the photosensitive drum 1 is formed. In this embodiment, the primary transfer roller 5 is constituted by the metal roller. As a material for the metal roller, SUM or SUS is used. With the primary transfer roller 5, a primary transfer voltage source (high voltage source) E1 (FIG. 5) as a primary transfer voltage applying means is connected. This metal roller is an example of an electroconductive member formed with a rigid member at a portion contacting the intermediary transfer belt 7. In this embodiment, the primary transfer roller 5 has a straight shape substantially uniform in outer diameter with respect to a thrust direction (rotational axis direction, longitudinal direction). In this embodiment, the outer diameter of the primary transfer roller 5 may suitably be about 6-10 μm, and particularly in this embodiment, the outer diameter of the primary transfer roller 5 is 8 mm. In this embodiment, a back-up member 11 is provided at the K image forming portion SK, and will be described later. In an outer peripheral (front) surface side (toner image carrying surface side) of the intermediary transfer belt 7 at a position opposing the secondary transfer opposite roller 75, the secondary transfer roller (outer secondary transfer roller) 8 which is a roller-shaped secondary transfer member as a secondary transfer means is disposed. The secondary transfer roller 8 is urged toward the secondary transfer opposite roller 75 and sandwiches the intermediary transfer belt 7 between itself and the secondary transfer opposite roller 75. As a result, a secondary transfer portion (secondary transfer nip) N2 which is a contact portion between the intermediary transfer belt 7 and the secondary transfer roller 8 is formed. In this embodiment, the secondary transfer opposite roller 75 is constituted by forming an elastic layer with EPDM rubber on a core metal, and is 20 mm in outer diameter, 0.5 mm in thickness of the elastic layer, and about 70 deg. in hardness (Asker C). In this embodiment, the secondary transfer roller 8 is constituted by forming an elastic layer with NBR rubber or EPDM rubber on a core metal and is 24 mm in outer diameter. With the secondary transfer roller 8, a secondary transfer voltage source (high voltage source) E2 (FIG. 5) as a secondary transfer voltage applying means is connected.

Further, in the outer peripheral surface side of the intermediary transfer belt 7, a belt cleaning device 10 as an intermediary transfer member cleaning means is provided downstream of the secondary transfer portion N2 (and upstream of the most upstream primary transfer portion N1Y) with respect to the rotational direction of the intermediary transfer belt 7. In this embodiment, the belt cleaning device 10 is disposed at a position opposing the driving roller 71 via the intermediary transfer belt 7.

The image forming apparatus 100 is further provided with a recording material feeding system for feeding a recording material P such as a recording sheet. The recording material feeding system includes a tray (not shown) for accommodating the recording material P and a pick-up roller (not shown) for picking-up and feeding the recording material P, accommodating in the (sheet) tray, at predetermined timing. Further, the recording material feeding system is provided with a registration roller pair 9 for feeding the recording material P, picked up by the pick-up roller, to the secondary transfer portion N2. The image forming apparatus 100 further includes a fixing device (not shown) for fixing the toner image on the recording material P.

During image formation, a surface of the rotationally driven photosensitive drum 1 is electrically charged substantially uniformly by the charging roller 2 to a predetermined polarity (negative in this embodiment) and a predetermined potential. The charged surface of the photosensitive drum 1 is subjected to scanning exposure to light depending on image information by the exposure device 3, so that an electrostatic latent image (electrostatic image) is formed on the surface of the photosensitive drum 1. The electrostatic latent image is formed on the photosensitive drum 1 is developed (visualized) with a toner into a toner image by the developing device 4. In this embodiment, the toner image is formed by image portion exposure and reverse development. That is, on an exposed portion on the photosensitive drum 1 where an absolute value of a potential is lowered by being exposed to light after being uniformly charged electrically, the toner charged to the same polarity as a charge polarity of the photosensitive drum 1 is deposited.

The toner image formed on the photosensitive drum 1 is electrostatically transferred (primary-transferred) at the primary transfer portion N1 onto the rotationally driven intermediary transfer belt 7 by the action of the primary transfer roller 5. At this time, to the primary transfer roller 5, from a primary transfer voltage source E1 (FIG. 5), a primary transfer voltage (primary transfer bias) which is a DC voltage of an opposite polarity to the charge polarity (normal charge polarity) of the toner during development is applied.

For example, during an operation in an full-color mode, by the above-described process, the color toner images of yellow, magenta, cyan and black formed on the photosensitive drums 1Y, 1M, 1C and 1K are successively transferred superposedly onto the intermediary transfer belt 7 at the primary transfer portions N1.

The toner image transferred on the intermediary transfer belt 7 is electrostatically transferred (secondary-transferred) onto the recording material P, sandwiched and fed between the intermediary transfer belt 7 and the secondary transfer roller 8, by the action of the secondary transfer roller 8. At this time, to the secondary transfer roller 8, from a secondary transfer voltage source E2 (FIG. 5), a secondary transfer voltage (secondary transfer bias) which is a DC voltage of an opposite polarity to the normal charge polarity of the toner is applied.

The recording material P on which the toner image is transferred is fed to the fixing device (not shown) and is heated and pressed by the fixing device, so that the toner image is fixed on the recording material P. Thereafter, the recording material P is discharged to an outside of an apparatus main assembly of the image forming apparatus 100.

On the other hand, a toner (transfer residual toner) remaining on the surface of the photosensitive drum 1 after a primary transfer step is removed from the surface of the photosensitive drum 1 by a cleaning device 6 and is collected.

The toner (secondary transfer residual toner) and paper dust remaining on the surface of the intermediary transfer belt 7 after the secondary transfer step is removed from the surface of the intermediary transfer belt 7 by a belt cleaning means 10 and is collected.

### 2. Image Forming Operation Mode

The image forming apparatus 100 in this embodiment is capable of executing an operation in a full-color mode (first mode) in which images are formed at all of the image forming portions SY, SM, SC, SK and an operation in a black (single color) mode (monochromatic mode, second mode) in which an image is formed only at the K image forming portion SK.

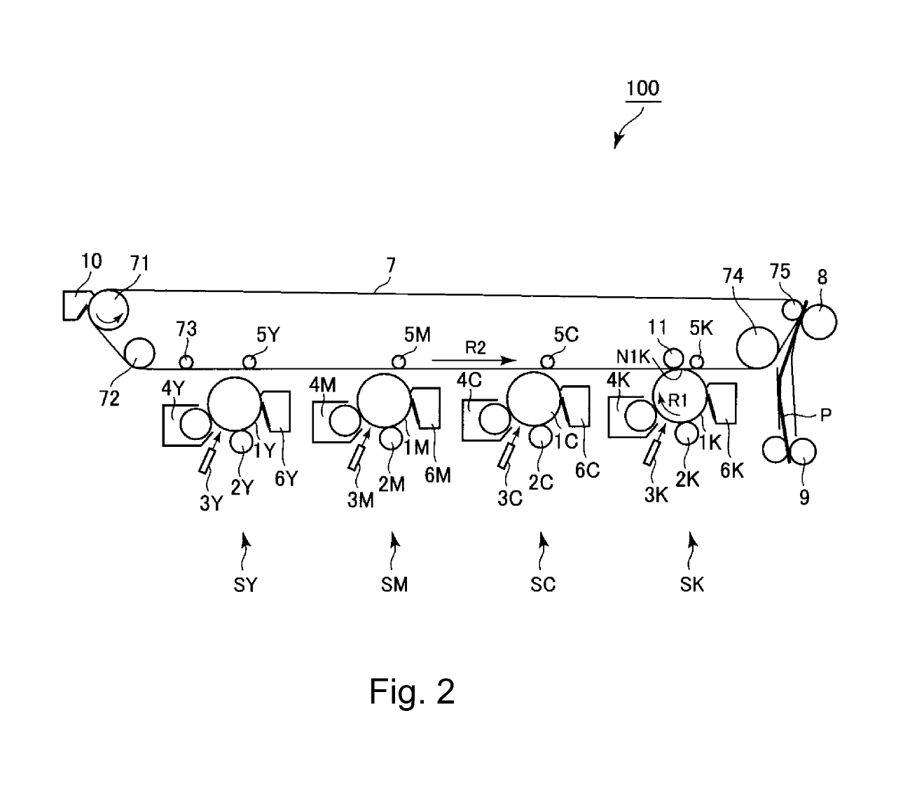

As shown in FIG. 1, in the operation in the full-color mode, the photosensitive drums 1Y, 1M, 1C, 1K of all of the image forming portions SY, SM, SC, SK and the intermediary transfer belt 7 are contacted to each other. Further, as shown in FIG. 2, in the operation in the black (monochromatic) mode, the photosensitive drum 1K of the K image forming portion SK and the intermediary transfer belt 7 are contacted to each other, and the photosensitive drums 1Y, 1M, 1C of the YMC image forming portions SY, SM, SC and the intermediary transfer belt 7 are spaced from each other. For that reason, the image forming portion 100 in this embodiment includes a contact and separation mechanism 50 (FIG. 5) as a contact and separation means for switching a contact state and a separated (spaced) state between the intermediary transfer belt 7 and the photosensitive drums 1Y, 1M, 1C of the YMC image forming portions SY, SM, SC. In this embodiment, the contact and separation mechanism 50 can move the first idler roller 73 and the YMC primary transfer rollers 5Y, 5M, 5C from the inner peripheral surface toward the outer peripheral surface and from the outer peripheral surface toward the inner peripheral surface. Further, during the operation in the black (monochromatic) mode, the contact and separation mechanism 50 retracts each of the first idler roller 73 and the YMC primary transfer rollers 5Y, 5M, 5C from the intermediary transfer belt 7, so that the photosensitive drum 1K and the intermediary transfer belt 7 are contacted to each other only at the K image forming portion SK.

In this embodiment, each of the idler roller 73 and the YMC primary transfer rollers 5Y, 5M, 5C is rotatably supported by a bearing member (not shown) at each of end portions thereof with respect to the longitudinal direction. Further, in this embodiment, the contact and separation mechanism 50 moves the bearing members for the first idler roller 73 and the YMC primary transfer rollers 5Y, 5M, 5C in a spacing direction from the photosensitive drums 1. As a result, the YMC primary transfer rollers 5Y, 5M, 5C are retracted from the intermediary transfer belt 7, so that the YMC photosensitive drums 1Y, 1M, 1C are spaced from the intermediary transfer belt 7.

The image forming operation in the full-color mode is as described above. Further, the image forming operation in the black (monochromatic) mode is similar to the above-described image forming operation in the full-color mode except that the toner image formation on the photosensitive drum 1 and the primary transfer of the toner image are performed at the K image forming portion SK.

### 3. Control Mode

FIG. 5 is a block diagram showing a schematic control mode of a principal part of the image forming apparatus 100 in this embodiment. The image forming apparatus 100 is provided with a controller 110 as a control means for effecting integrated control of the respective portions of the image forming apparatus 100. The controller 110 is constituted by including CPU which is a central element (unit) for performing computation (operation), memories, such as ROM and RAM, which are storing elements (memories) as storing means, and the like. In the RAM, a detection result of the sensors, a computation result, and the like are stored, and in the ROM, a control program, a data table acquired in advance, and the like are stored. In this embodiment, a driving motor for driving the photosensitive drums 1 and the intermediary transfer belt 7, the primary transfer voltage source E1, the secondary transfer voltage source E2, the contact and separation mechanism 50, and many objects to be controlled in the image forming operation are connected with the controller 110.

FIG. 6 is a flowchart schematically showing a procedure of an image outputting operation (job). The image outputting operation (job) is a series of operations for forming and outputting images on a single or a plurality of recording materials by a single start instruction. First, by an operator such as a user, the species of the recording material P used for image formation is selected and inputted into the controller 110 (Step 1). Incidentally, in an evaluation test described later or the like, in this step, thick paper (A3-sized paper: 209 gsm) is selected. Then, the controller 110 performs, when the image outputting operation is started (Step 2), post-rotation which is a step of effecting various pieces of control such as registration control and gradation control (Step 3). Then, the controller 110 effects image formation including steps in which the formation, the primary transfer and the secondary transfer of the toner images are actually performed (Step 4). Thereafter, the controller 110 stops, after post-rotation which is a step of turning off of the various high voltage applications and various drives, the operation of the image forming apparatus (Step 5), and then ends the image outputting operation (Step 6).

### 4. Arrangement Relationship Between Photosensitive Drum and Primary Transfer Roller

In FIG. 3, (a) is a schematic view showing an arrangement relationship between the photosensitive drum 1 and the primary transfer roller 5 in this embodiment. In this embodiment, at all of the image forming portions S, the arrangement relationship between the photosensitive drum 1 and the primary transfer roller 5 is the same. Further, (a) of FIG. 3 shows the arrangement relationship in a state in which the photosensitive drum 1 contacts the intermediary transfer belt 7 and the toner image can be transferred from the photosensitive drum 1 onto the intermediary transfer belt 7.

In this embodiment, the primary transfer roller 5 is a metal roller of 8 mm in outer diameter. The primary transfer roller 5 is disposed so as to contact the inner peripheral surface of the intermediary transfer belt 7 in a state in which the primary transfer roller 5 does not oppose the photosensitive drum 1 via the intermediary transfer belt 7 (a region where all of the photosensitive drum 1, the intermediary transfer belt 7 and the primary transfer roller 5 contact each other is not formed). Particularly, in this embodiment, the primary transfer roller 5 is disposed so as to be offset downstream of the photosensitive drum 1 with respect to the movement direction of the intermediary transfer belt 7. Specifically, in this embodiment, the primary transfer roller 5 is disposed at a position where an offset amount A shown in (a) of FIG. 3 is 7 mm. The offset amount A is a distance (along a common contact plane of the photosensitive drums 1) between a perpendicular drawn from a rotation center axis of each photosensitive drum 1 to the common contact plane and a perpendicular drawn from a rotation center axis of each primary transfer roller 5 to the common contact plane.

In this embodiment, the primary transfer roller 5 is disposed so as to cause the intermediary transfer belt 7 to project from the inner peripheral surface side toward the outer peripheral surface-side thereof substantially in a vertical direction with respect to the common contact plane (downward in (a) of FIG. 3) by 0.1-0.3 mm. As a press-contact method of the primary transfer roller 5 against the intermediary transfer belt 7, a method of controlling a press-contact force (total pressure) exerted from the inner peripheral surface side toward the outer peripheral surface side of the intermediary transfer belt 7 by supporting the bearing member for the primary transfer roller 5 via a spring as an urging means may also be employed.

As described above, in the case where an elastic roller having a rubber layer or a foam layer as the surface layer is used as the primary transfer roller 5, the primary transfer roller 5 is disposed in general in the following manner. The primary transfer roller 5 is disposed so as to oppose the photosensitive drum 1 via the intermediary transfer belt 7 (form a region where all of the photosensitive drum 1, the intermediary transfer belt 7 and the primary transfer roller 5 contact each other). In this case, the primary transfer roller 5 sandwiches the intermediary transfer belt 7 between itself and the photosensitive drum 1. In the case of such an arrangement relationship, a sufficient force of constraint between the photosensitive drum 1 and the intermediary transfer belt 7 can be easily obtained. For that reason, in either of the operations in the full-color mode and the black (monochromatic) mode, an image defect (shock image) due to transmission of shock or the like to the primary transfer portion N1 generating, for example, when the thick paper enters the secondary transfer portion N2 does not readily generate.

However, as in this embodiment, in the case where the primary transfer roller 5 is constituted by a rigid electroconductive member such as the metal roller, it is desired in some cases that the primary transfer roller 5 is disposed so as not to oppose the photosensitive drum 1 via the intermediary transfer belt 7. This is because as described above, a large change in current, supplied to the primary transfer portion N1, due to a difference in image ratio with respect to the longitudinal direction of the primary transfer roller 5 is suppressed. In this case, the primary transfer roller 5 does not sandwich the intermediary transfer belt 7 between itself and the photosensitive drum 1. For that reason, in the case of such an arrangement relationship, the force of constraint between the photosensitive drum 1 and the intermediary transfer belt 7 is weaker than that in the case of the arrangement relationship in which the intermediary transfer belt 7 is sandwiched between the primary transfer roller 5 and the photosensitive drum 1. As a result, the image defect (shock image) due to the transmission of shock or the like to the primary transfer portion N1 generating, for example, when the thick paper enters the secondary transfer portion N2 is liable to generate.

### 5. Back-Up Member

In view of the above-described problems, the image forming apparatus 100 in this embodiment has a constitution in which a back-up member 11, provided correspondingly to a part of the plurality of photosensitive drums 1, for sandwiching the intermediary transfer belt 7 between itself and the photosensitive drum 1 is disposed. It is desirable that from the viewpoints of simplification, cost reduction and the like of an apparatus structure, the image defect due to the shock can be sufficiently suppressed by the back-up member 11 in a small number thereof to the possible extent. For that reason, the back-up member 11 may preferably be disposed at least at the most downstream K image forming portion SK, with respect to the rotational direction of the intermediary transfer belt 7, closest to the secondary transfer portion N2 capable of constituting a principal shock generating source in the image forming apparatus 100 of the intermediary transfer type. Further, from another viewpoint, in the case where operations in a plurality of modes (image forming modes) in which the number of image forming portions used for image formation is different are performed, the back-up member 11 may preferably be provided at least at the image forming portion S which is used in any of the plurality of modes. As in this embodiment, in the case where the operations in the full-color mode and the black (monochromatic) mode are performed, the back-up member 11 may preferably be provided at least at the K image forming portion SK where the image is formed in the operation in the black (monochromatic) mode. Therefore, in this embodiment, the back-up member 11 is provided correspondingly to the photosensitive drum 1K of the most downstream K image forming portion SK with respect to the rotational direction of the intermediary transfer belt 7. In the following, description will be made specifically.

In FIG. 3, (b) is a schematic view showing an arrangement relationship among the K photosensitive drum 1K, the K primary transfer roller 5K and the back-up member 11 in this embodiment.

In this embodiment, the back-up member 11 is an elastic roller, constituted by including an elastic layer on a core metal (core material), having an outer diameter of 12 mm and a hardness (Asker C) of 25 deg. Particularly, in this embodiment, as the back-up member 11, a sponge roller constituted by forming a foam layer, as the elastic layer, of NBR rubber of 1×10⁷ Ω·cm in volume resistivity on the core metal of SUM of 8 mm in diameter was used.

The core metal of the back-up member 11 is not electrically grounded and is in a state in which an electroconductive path with a peripheral high voltage applying member is not formed, i.e., is electrically float. This is because a high voltage is applied to the K primary transfer roller 5K, and therefore electric interference by the back-up member 11 is suppressed, and thus a current flowing from the K secondary transfer roller 5K flows into the K photosensitive drum 1K substantially entirety.

In this embodiment, the back-up member 11 disposed so as to be offset upstream of the K photosensitive drum 1K with respect to the movement direction of the intermediary transfer belt 7. Specifically, in this embodiment, the back-up member 11 is disposed at a position where an offset amount B shown in (b) of FIG. 3 is 3 mm. The offset amount B is a distance (along a common contact plane of the photosensitive drums 1) between a perpendicular drawn from a rotation center axis of the K photosensitive drum 1K to the common contact plane and a perpendicular drawn from a rotation center axis of the back-up member 11 to the common contact plane.

In this embodiment, a load exerted on the corresponding K photosensitive drum 1K by the back-up member 11 was 600 gf or more and 2000 gf or less. This is for the following reasons. That is, in the case where this load is less than 600 gf, the force of constraint between the photosensitive drum 1 and the intermediary transfer belt 7 cannot be sufficiently obtained, so that it becomes difficult to suppress generation of the image defect due to the shock in some cases. Further, in the case where the load is larger than 2000 gf, the pressure at the primary transfer portion N1 becomes excessively large, so that an image defect which is called “void (hollow image)” in which a central portion of a vertical line image is dropped is liable to generate, for example.

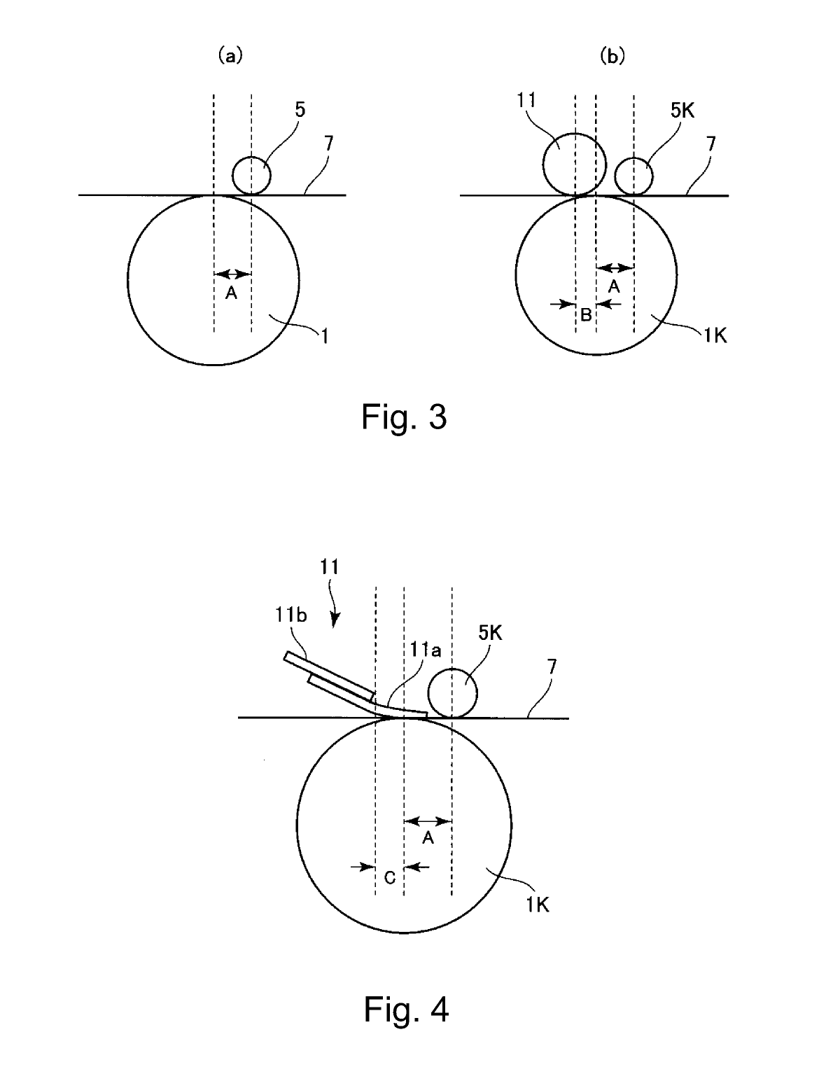

The back-up member 11 is not limited to the elastic roller as in this embodiment. FIG. 4 is a schematic view showing another application example of the back-up member 11. In the example of FIG. 4, the back-up member 11 is constituted by a rubber blade (elastic blade) 11a and a metal plate (supporting member) 11b formed of metal as a rigid member. The rubber blade 11a is a 2 mm-thick plate-like member which is provided along the longitudinal direction of the photosensitive drum 1 and which has a predetermined length with respect to each of a longitudinal direction and a widthwise (short) direction perpendicular to the longitudinal direction. The rubber blade 11a is bonded and fixed to the metal plate 11b and has a free length (from a free end to a portion supported by the metal plate 11b with respect to the widthwise direction) of 5 mm. An angle formed between the metal plate 11b and the surface of the intermediary transfer belt 7 is about 30 deg. The back-up member 11 is urged by a spring as an urging means so that a load exerted on the corresponding K photosensitive drum 1K by the rubber blade 11a is 1000 gf. In the example of FIG. 4, the free end of the rubber blade 11a extends to a position downstream of the perpendicular, drawn from the rotation center axis of the K photosensitive drum 1 to the common contact plane of the photosensitive drums 1, with respect to rotational direction of the intermediary transfer belt 7. The free end of the metal plate 11b (on the free end side of the rubber blade 11a) is disposed at a position where an offset amount C shown in FIG. 4 is 3 mm. This offsets amount C is a distance (along the common contact plane) between the perpendicular drawn from the rotation center axis of the K photosensitive drum 1K to the common contact plane and the perpendicular drawn from the free end of the metal plate 11b to the common contact plane.

In this embodiment, the back-up member 11 is kept in a state in which the back-up member 11 opposes the K photosensitive drum 1K via the intermediary transfer belt in both of during the operation in the full-color mode and during the operation in the black (monochromatic) mode.

During the operation in the full-color mode, the intermediary transfer belt 7 is press-contacted to the photosensitive drums 1 at the plurality of image forming portions S, and therefore the case where the image defect due to the shock does not significantly generate without using the back-up member 11 would be considered. In the case of such a constitution, from the viewpoint that a deterioration of the back-up member 11 is suppressed, during the operation in the full-color mode, the back-up member 11 can be retracted from the intermediary transfer belt 7. For this reason, as a contact and separation means for the back-up member 11, a contact and separation mechanism having the same constitution as the above-descried contact and separation mechanism for the primary transfer rollers 5 can be used.

### 6. Evaluation Method and Evaluation Result

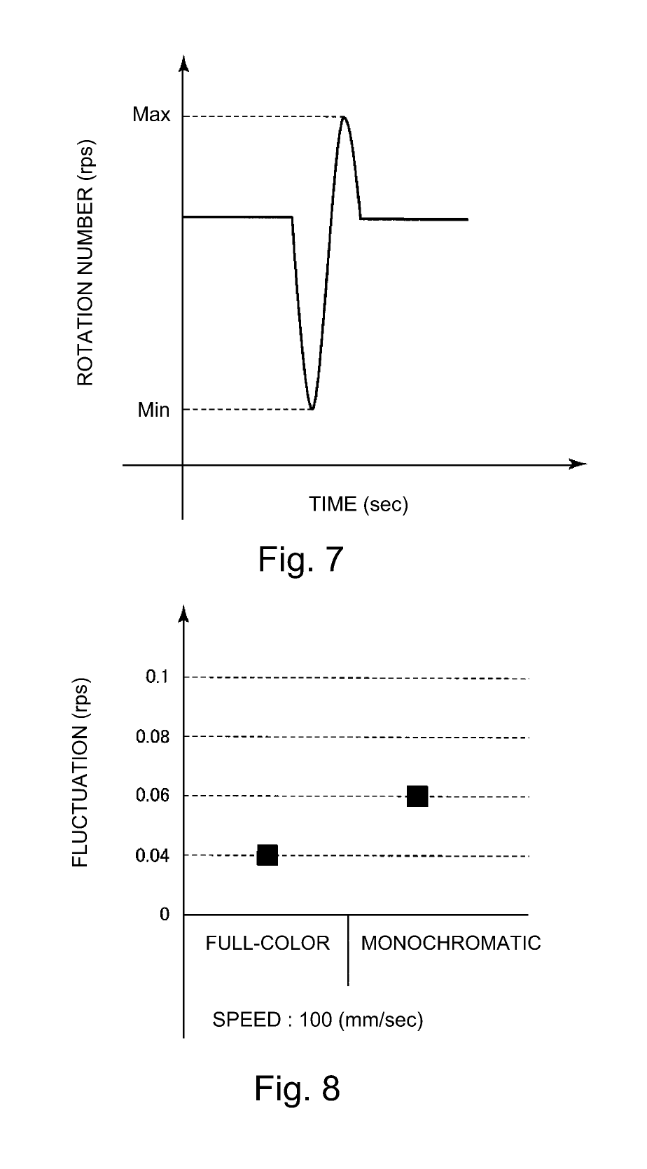

Next, an evaluation method and an evaluation result of an effect in this embodiment will be described. FIG. 7 is a graph showing a change with time of a feeding speed of the intermediary transfer belt 7 (i.e., the rotation number (rps) of the driving roller 71) when the thick paper (a3-sized paper: 209 gsm) enters the secondary transfer portion N2. A result shown in FIG. 7 is an outline of a result of detection of the rotation number made by connecting a rotary encoder (“UN-2000”, manufactured by MUTCH Engineering Inc.) with a shaft of the driving roller 71. It is understood that the rotation number of the driving roller 71 largely fluctuates by entering of the thick paper into the secondary transfer portion N2. A difference between a maximum and a minimum of the rotation number is a rotation fluctuation used as an evaluation criterion.

FIG. 8 shows the rotation fluctuation in each of the operations in the full-color mode and the black (monochromatic) mode. In this embodiment, the feeding speed of the thick paper is 100 mm/sec. From FIG. 8, it is understood that the rotation fluctuation is larger in the operation in the black (monochromatic) mode than in the operation in the full-color mode.

Table 1 shows the evaluation result of the rotation fluctuation and the image defect due to the shock in the case where the back-up member 11 is not provided (Comparison Example) and in the case where the back-up member 11 is provided (Embodiment 1). The image defect was evaluated on the basis of whether or not the image defect was able to be discriminated by eye observation as follows.

o: No image defect generated.

Δ: The image defect somewhat generated but was at a level of no problem.

x: The image defect generated and was at a problematic level.

TABLE 1

| | | |
|---|---|---|
| FS*¹ | FCM*² | BM*⁵ |

| 100 (mm/sec) | RF*³ (rps) | ID*⁴ | RF*³ (rps) | ID*⁴ |
|---|---|---|---|---|
| COMP. EX. | 0.15 | Δ | 0.2 | x |
| EMB. 1 | 0.04 | ∘ | 0.06 | ∘ |

*¹“FS” is the feeding speed.
*²“FCM” is the full-color mode.
*³“BM” is the black (monochromatic) mode.
*⁴“RF” is the rotation fluctuation.
*⁵“ID” is the image defect.

From Table 1, it is understood that the rotation fluctuation can be suppressed in a large degree by providing the back-up member 11. As a result, it is understood that the image defect due to the shock can be sufficiently suppressed. Particularly, it is understood that the above effect can be conspicuous obtained in the black (monochromatic) mode in which the rotation fluctuation and the image defect due to the shock are liable to generate.

As described above, in this embodiment, the primary transfer roller 5 is disposed at a position where the primary transfer roller 5 does not oppose the photosensitive drum 1 via the intermediary transfer belt 7. In such a constitution, in this embodiment, the back-up member 11 for sandwiching the intermediary transfer belt 7 between itself and the photosensitive drum 1K is provided correspondingly to the photosensitive drum 1K of the most downstream image forming portion SK with respect to the rotational direction of the intermediary transfer belt 7. As a result, by the force of constraint for the intermediary transfer belt 7 by the back-up member 11 and the photosensitive drum 1, it becomes possible to suppress the image defect due to the shock generating when, e.g., the thick paper enters the secondary transfer portion N2. In this embodiment, the back-up member 11 electrically floats. As a result, electrical interference by the back-up member 11 can be suppressed with high reliability. In this embodiment, the back-up member 11 is formed with an elastic member at a portion contacting the intermediary transfer belt 7. As a result, it is possible to enhance power for constraining the intermediary transfer belt 7 by sandwiching the intermediary transfer belt 7 between the back-up member 11 and the photosensitive drum 1. Particularly, in this embodiment, the back-up member 11 is provided only at the most downstream image forming portion SK, with respect to the rotational direction of the intermediary transfer belt 7, which is closest to the secondary transfer portion N2 and at which the image formation is effected in both of the operations in the full-color mode and the black (monochromatic) mode. As a result, it is possible to effectively suppress the generation of the image defect due to the shock while realizing the simplification and the cost reduction of the apparatus structure.

### Embodiment 2

Another embodiment of the present invention will be described. Basic constitution and operation of an image forming apparatus in this embodiment are the same as those in Embodiment 1. Accordingly, elements having the same or corresponding functions and constitutions as those for the image forming apparatus in Embodiment 1 are represented by the same reference numerals or symbols, and will be omitted from detailed description.

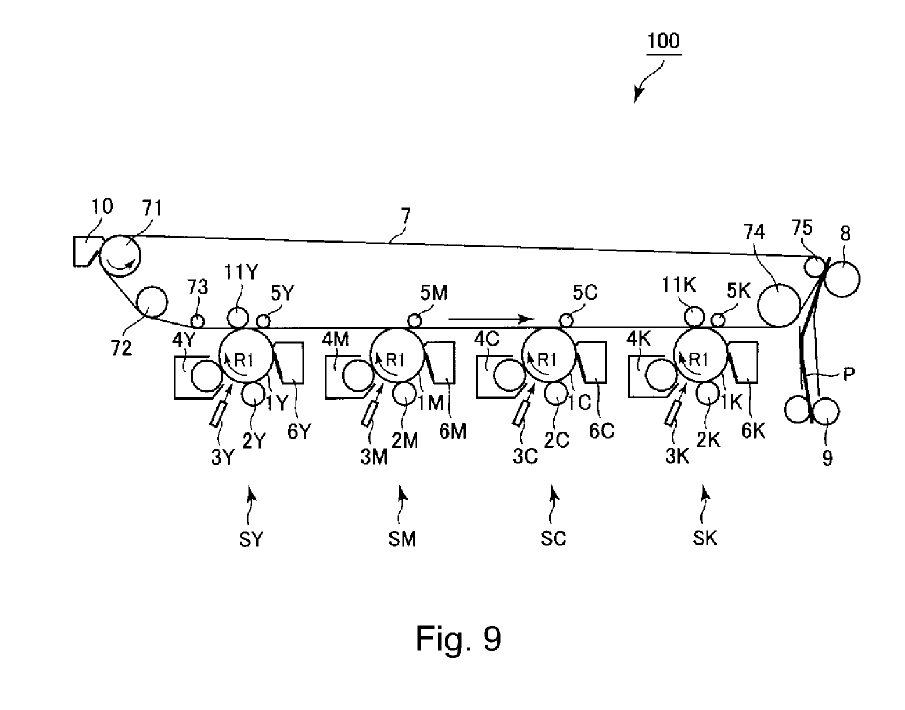

FIG. 9 is a schematic sectional view of the image forming apparatus in this embodiment during the operation in the full-color mode. In this embodiment, back-up members 11Y, 11K are provided correspondingly to the photosensitive drums 1Y, 1K, respectively, of the most upstream Y image forming portion SY and the most downstream K image forming portion SK with respect to the rotational direction of the intermediary transfer belt 7.

That is, in order to further enhance the effect of suppressing the image defect due to the shock, it is effective to provide the back-up members 11 correspondingly to the plurality of photosensitive drums 1. At this time, in the case where the back-up member 11 is provided at least at the most downstream image forming portion SK as described in Embodiment 1, another back-up member 11 may preferably be provided at least at the most upstream image forming portion SY. This is because in the case where the back-up member 11 is provided at the most downstream image forming portion SK, a portion where the shock is liable to be subsequently transferred with respect to a circumferential direction of the intermediary transfer belt 7 is the most upstream image forming portion SY.

The constitution and arrangement relationship of the back-up member 11Y provided at the Y image forming portion SY in this embodiment are the same as those of the back-up member 11M provided at the K image forming portion SK. The constitution and arrangement relationship of the back-up member 11M provided at the K image forming portion SK in this embodiment are the same as those in Embodiment 1. However, the back-up member 11Y provided at the Y image forming portion SY is retracted from the intermediary transfer belt 7 in the operation in the black (monochromatic) mode and enables spacing of the intermediary transfer belt 7 from the photosensitive drum 1Y at the Y image forming portion SY. As the contact and separation means for the back-up member 11Y for this purpose, it is possible to use the contact and separation mechanism having the same constitution as the above-described contact and separation mechanism for the primary transfer rollers 5.

Table 2 shows an evaluation result of the rotation fluctuation and the image defect due to the shock in the case where both of the back-up members 11Y, 11K are not provided (Comparison Example) and in the case where both of the back-up members 11Y, 11K are provided (Embodiment 2). The measuring method of the rotation fluctuation and the evaluation method of the image defect are the same as those in Embodiment 1. However, the feeding speed of the thick paper (A3-sized paper: 209 gsm) is 200 mm/sec (twice the feeding speed in Embodiment 1).

TABLE 2

| | | |
|---|---|---|
| FS*¹ | FCM*² | BM*⁵ |

| 200 (mm/sec) | RF*³ (rps) | ID*⁴ | RF*³ (rps) | ID*⁴ |
|---|---|---|---|---|
| COMP. EX. | 0.3 | x | 0.4 | x |
| EMB. 2 | 0.06 | ∘ | 0.12 | Δ |

*¹“FS” is the feeding speed.
*²“FCM” is the full-color mode.
*³“BM” is the black (monochromatic) mode.
*⁴“RF” is the rotation fluctuation.
*⁵“ID” is the image defect.

From Table 2, in the operation in the black (monochromatic) mode, the same constitution as that in Embodiment 1 is employed, and therefore the effect of suppressing the image defect due to the shock was lowered correspondingly to the increased feeding speed (twice the feeding speed in Embodiment 1) of the thick paper although the level thereof is a level of no problem. On the other hand, in the operation in the full-color mode, it is understood that the rotation fluctuation which becomes conspicuous by the increased feeding speed (twice the feeding speed in Embodiment 1) of the thick paper is largely suppressed. As a result, it is understood that the image defect due to the shock generated by the increased thick paper feeding speed (twice the feeding speed in Embodiment 1) can be sufficiently suppressed.

As described above, by providing the back-up member 11 also at another image forming portion S in addition to the most downstream image forming portion S, the effect of suppressing the image defect due to the shock can be improved. At this time, as described above, the back-up member 11 may preferably be provided at least at the mode image forming portion SY. As a result, it is possible to meet also a constitution in which the feeding speed of the recording material P is relatively fast.

### OTHER EMBODIMENTS

The present invention was described above based on the specific embodiments, but is not limited to the above-described embodiments.

For example, in the above-described embodiments, the operation in the mode in which the image is formed only at a part of the image forming portions is the operation in the black (monochromatic) mode, but may also be the operation in a single-color (monochromatic) mode of another color. Further, an operation in a two-color mode using, for example, the black toner and the cyan toner and an operation in a three-color mode using the magenta, cyan and black toners without using the yellow toner only may also be performed. Also in these cases, similarly as in the embodiments described above, the back-up member may preferably be provided at least at the image forming portion used in both of the operations in the mode in which the image formation is effected only at the part of the image forming portions and in the mode in which the image formation is effected at all of the image forming portions.

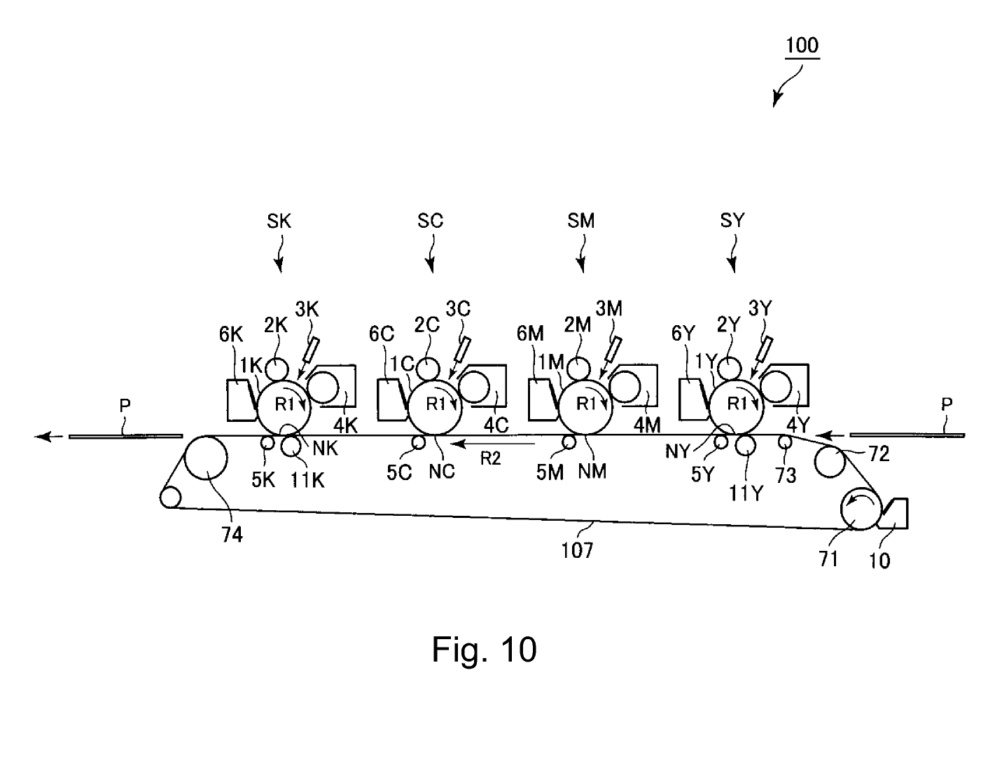

In the above-described embodiments, the image forming apparatus of the intermediate transfer type was described as an example, but the present invention is also applicable to an image forming apparatus of a direct transfer type. FIG. 10 is a schematic sectional view of a principal part of the image forming apparatus (full-color mode) of the direct transfer type. In FIG. 10, elements having the same or corresponding functions or constitutions are represented by the same reference numerals or symbols. The image forming apparatus 100 in FIG. 10 includes, in place of the intermediary transfer belt 7, a recording material carrying belt 107 constituted by an endless belt as a recording material carrying member. The recording material carrying belt 107 is an example of a rotatable endless belt for carrying the recording material onto which the toner images are transferred from the plurality of image bearing members and for feeding the recording material to the contact portions with the plurality of the image bearing members. In the image forming apparatus 100 in FIG. 27, each of toner images formed on the photosensitive drums 1 at the image forming portions S is transferred at the transfer portions N onto the recording material P carried and fed on the recording material carrying belt 107. Also in such an image forming apparatus 100 of the direct transfer type, in the case where the primary transfer rollers 5 are disposed so as not to oppose the photosensitive drums 1 via the intermediary transfer belt 7, there is a liability that the image defect due to the shock given to the recording material carrying belt 107 generates. For example, it would be considered that when the thick paper enters a transfer portion of the recording material carrying belt, the shock is given to the recording material carrying belt. Accordingly, the present invention is also applicable to the image forming apparatus of the direct transfer type, and effects similar to those in the above-described embodiments can be obtained.

In the image forming apparatus 100 of the direct transfer type, the back-up member 11 may preferably be provided at the most upstream image forming portion SY, with respect to the rotational direction of the recording material carrying belt 107, closest to the portion where the recording material P enters the transfer portion of the recording material carrying belt 107. From another viewpoint, similarly as in the above-descried embodiments, it is preferable that the back-up member 11 is provided at the image forming portion S where the image formation is effected in either of the operations in the plurality of modes. Accordingly, for example, in the case of the constitution as shown in FIG. 10, the back-up members 11Y, 11K can be provided correspondingly to the photosensitive drums 1Y, 1K, respectively at the mode Y image forming portion SY and the most downstream K image forming portion SK.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-054039 filed on Mar. 17, 2015, which is hereby incorporated by reference herein in its entirety.

What is claimed is:

1. An image forming apparatus comprising:
a plurality of image bearing members;
an image forming unit for forming toner images on said image bearing members, respectively;
a movable endless belt onto which the toner images are transferred from said image bearing members at a plurality of transfer portions corresponding to said image bearing members, respectively, wherein each of the transfer portions is a contact portion where an outer peripheral surface of said belt and an associated image bearing member are in contact with each other;
a plurality of transfer members provided in contact with an inner peripheral surface of said belt and in neighborhoods of the transfer portions, wherein each of said transfer members is disposed at a position shifted toward a downstream side relative to an associated contact portion with respect to a movement direction of said belt;
a voltage source for applying a voltage to said transfer members; and
an urging member for urging said belt to an associated image bearing member in contact with the inner peripheral surface of said belt, said urging member being provided correspondingly to at least one of said image bearing members.

2. An image forming apparatus according to claim 1, wherein said belt is an intermediary transfer member on which the toner images transferred from said image bearing members at the transfer portions are once carried.

3. An image forming apparatus according to claim 1, wherein said urging member is provided correspondingly to a part of said image bearing members including a most downstream image bearing member with respect to the movement direction of said belt.

4. An image forming apparatus according to claim 1, wherein said urging member is provided correspondingly to a most downstream image bearing member, of said image bearing members, with respect to the movement direction of said belt.

5. An image forming apparatus according to claim 4, wherein said urging member is provided correspondingly to an urging member image bearing member with respect to the movement direction of said belt.

6. An image forming apparatus according to claim 1, wherein said image forming apparatus is capable of executing an operation in a first mode in which the toner images are formed on all of said image bearing members and then are transferred onto said belt and an operation in a second mode in which the toner image is formed on a part of said image bearing members including a most downstream image bearing member and then is transferred onto said belt,
wherein the operation in the second mode is executed in a state in which said belt is spaced from all of said image bearing members other than said image bearing member on which the toner image is formed in the operation in the second mode, and
wherein said urging member is provided correspondingly to the part of said image bearing members including the most downstream image bearing member.

7. An image forming apparatus according to claim 1, wherein said image forming apparatus is capable of executing an operation in a first mode in which the toner images are formed on all of said image bearing members and then are transferred onto said belt and an operation in a second mode in which the toner image is formed on a part of said image bearing members and then is transferred onto said belt,
wherein the operation in the second mode is executed in a state in which said belt is spaced from all of said image bearing members other than said image bearing member on which the toner image is formed in the operation in the second mode, and
wherein said urging member is provided correspondingly to the part of said image bearing members, on which the toner image is formed in the operation in the second mechanism.

8. An image forming apparatus according to claim 6, wherein said urging member is spaced from said belt when the operation in the first mode is executed.

9. An image forming apparatus according to claim 7, wherein said urging member is spaced from said belt when the operation in the first mode is executed.

10. An image forming apparatus according to claim 1, wherein each of said transfer members is formed with a rigid member having electroconductivity at a portion contacting said belt.

11. An image forming apparatus according to claim 1, wherein each of said transfer members is a metal roller.

12. An image forming apparatus according to claim 1, wherein said urging member is formed with an elastic member at a portion contacting said belt.

13. An image forming apparatus according to claim 1, wherein said urging member is an elastic roller or an elastic belt.

14. An image forming apparatus according to claim 1, wherein said urging member electrically floats.

15. An image forming apparatus according to claim 1, wherein a load exerted on an associated image bearing member by said urging member is 600 gf or more and 2000 gf or less.
